(19) United States
(12) Patent Application Publication
(10) Pub. No.: US 2014/0191843 A1
(43) Pub. Date: Jul. 10, 2014

(54) MACHINE SECURITY SYSTEM

(71) Applicant: CATERPILLAR INC, Peoria, IL (US)

(72) Inventors: Mark T. DeCou, Peoria, IL (US); Paul D. Smith, Dunlap, IL (US); Anton D. Volkov, Morton, IL (US)

(73) Assignee: Caterpillar Inc, Peoria, IL (US)

(21) Appl. No.: 13/734,112

(22) Filed: Jan. 4, 2013

(51) Int. Cl. G05B 1/01

(52) U.S. Cl. CPC G05B 1/01
USPC 340/5.61

(57) ABSTRACT

A machine security system for authenticating a machine key is disclosed. The machine security system comprises a microcontroller for detecting insertion of a machine key in a key slot of the machine. The machine key comprises of an embedded transponder. Based on detection of the machine key in the key slot, the microcontroller transmits an interrogation signal for charging the transponder. The microcontroller then receives a response signal from the transponder. The transponder sends the response signal when substantially charged by the interrogation signal. The response signal is encoded with an authentication code for authenticating the machine key. The microcontroller decodes the authentication code from the received response signal and authenticates the machine key based on the decoded authentication code.

### TECHNICAL FIELD

The present disclosure relates to a machine security system and more particularly, to a machine security system for authenticating a machine key.

### BACKGROUND

Machine security systems, for authentication of a machine key, are employed within various machines in order to avoid unauthorized and/or improper usage of the machines. For example, U.S. Pat. No. 8,207,831 (The '831 patent) describes one such system. The '831 patent relates to a transponder demodulator for a low antenna limiter threshold. A radio frequency identification (RFID) transponder includes an antenna for receiving a radio-frequency (RF) signal. The RF signal includes a modulated downlink data signal. The RFID transponder further includes a demodulating stage coupled to the antenna for receiving a derived RF signal from the received RF signal. The demodulating stage has a first filter for extracting field strength signal component from the derived RF signal and a second filter for extracting the modulated downlink data signal component from the derived RF signal. A demodulator coupled to the second filter receives the modulated downlink signal component for demodulation. The demodulator is further coupled to the first filter to receive the field strength signal such that the demodulator is adapted to vary a demodulation sensitivity parameter in response to the field strength signal.

Most of the existing machine security systems include multiple discrete circuits and/or components for authentication of a machine key. However, these systems may be prone to compromised machine security, higher implementation costs, and/or larger footprints for packaging. The present disclosure is directed to overcome one or more of the problems as set forth above.

### SUMMARY

In one aspect, the present disclosure provides a machine security system for authenticating a machine key. The machine security system includes a microcontroller for detecting insertion of a machine key, having a transponder embedded within, in a key slot of a machine. If insertion of the machine key in the key slot of the machine is detected, the microcontroller transmits an interrogation signal to the transponder. The microcontroller then receives a response signal from the transponder. The transponder may transmit the response signal when it is substantially charged by the interrogation signal. The response signal includes an encoded authentication code for authenticating the machine key. The microcontroller receives the response signal and decodes the response signal for extracting the authentication code. The microcontroller authenticates the machine key based on the decoded authentication code.

Other features and aspects of this disclosure will be apparent from the following description and the accompanying drawings.

### BRIEF DESCRIPTION OF THE DRAWINGS

FIG. 1 is an exemplary machine implementing a machine security system in accordance with an embodiment of the present disclosure;

FIG. 2 is an exemplary block diagram depicting working of different components of the machine security system in accordance with an embodiment of the present disclosure; and

FIG. 3 is an exemplary process flow for authenticating a machine key by the machine key system, in accordance with an embodiment of the present disclosure.

### DETAILED DESCRIPTION

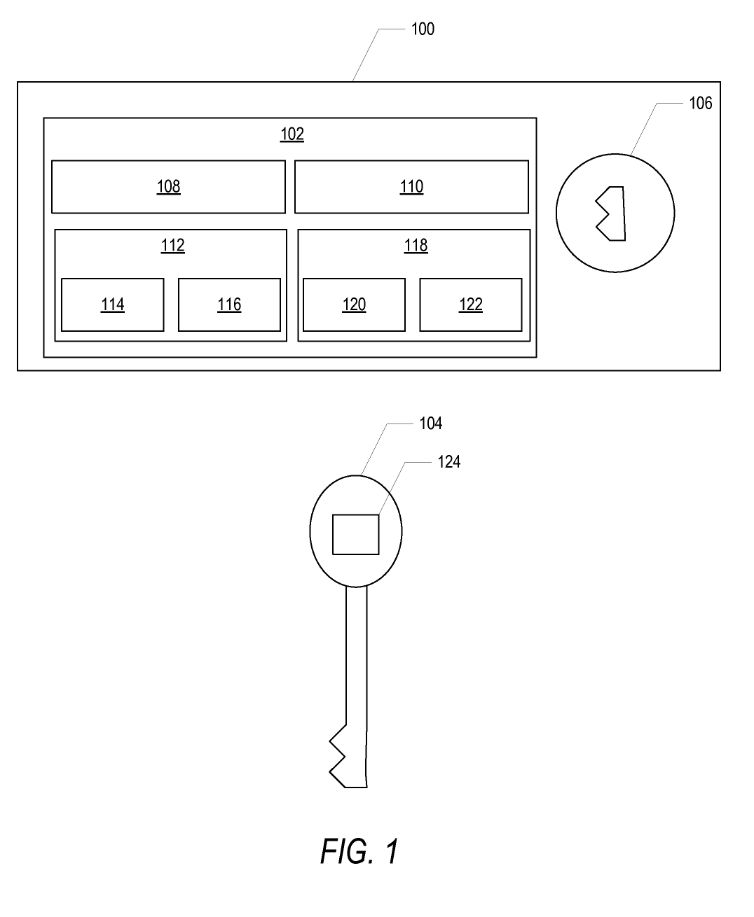

The present disclosure relates to machine security system for authenticating a machine key. FIG. 1 illustrates a machine 100 in accordance with an embodiment of the present disclosure. The machine 100 may be any industrial and/or commercial machine, for example, but not limited to, trucks, loaders, planers, cars, drills, milling and tooling machines, industrial process equipment and the like. In an embodiment, as depicted in FIG. 1, the machine 100 may embody a machine security system 102 for authenticating a machine key 104. The machine 100 may further include a key slot 106, in which the machine key 104 is inserted, for controlling one or more operations of the machine 100. The operations may include switching on, gaining entry to the machine, changing machine operating parameters, and so forth. The machine security system 102 may include a microcontroller 108, and an antenna coil 110. In various embodiments, the machine security system 102 may also include a transmission side filtering and amplification unit 112 (hereinafter “TX filtering and amplification unit 112). The TX filtering and amplification unit 112 may include a transmission side filter 114 (TX filter 114) and a transmission side amplifier 116 (TX amplifier 116). The machine security system 102 may further include a receiving side filtering and amplification unit 118 (RX filtering and amplification unit 118). The RX filtering and amplification unit may include a receiving side filter 120 (RX filter 120) and a receiving side amplifier 122 (RX amplifier 122). In an exemplary implementation, the microcontroller 108 may be electrically coupled to the antenna coil 110 via the TX filtering and amplification unit 112 on the transmission side and via the RX filtering and amplification unit 118 on the receiving side.

Examples of the microcontroller may include, but not limited to, those manufactured by Freescale semiconductors (e.g.: ColdFire, 68HC11, etc.), Intel (e.g.: 8051), Infineon, e.g.: MIPS), ARM (e.g.: Cortex), and the like. The microcontroller 108 may authenticate the machine key 104 on receiving an authentication code from a transponder 124 embedded within the machine key 104.

The microcontroller 108 may be configured to generate one or more digital signals to be transmitted to the transponder 124. The microcontroller 108 may generate the digital signals approximating a sinusoidal or other periodic waveform, at a frequency required to interrogate the transponder 124, for example, at a frequency in the LF band, such as 134.2 kHz. The digital signals may be filtered by the TX filter 114 and amplified by the TX amplifier 116. The TX amplifier 116 may be a power amplifier to amplify the digital signals to a power level capable of driving the antenna coil 110. The TX filter 114 is configured to filter the digital signals to reduce harmonic content of the digital signals to be applied to the antenna coil 110. The TX filtering and amplification unit 112 may then drive the antenna coil 110 with the amplified and filtered digital signals (referred to herein as the interrogation signals). The interrogation signals may then be transmitted to the transponder 124 through the antenna coil 110.

The interrogation signals may include a digital signal encoded with a suitable radio communication modulation technique, for example, Frequency Shift Keying (FSK). The microcontroller 108 may be configured to operate in the low frequency (LF) band between 120 kHz and 150 kHz. In some other embodiments, the microcontroller 108 may be configured to operate in high frequency (HF) band (for example, 5 MHz to 25 MHz), the ultra high frequency (UHF) ISM band (for example, 100 MHz to 1 GHz), or the microwave band (for example, 2.4 GHz to 10 GHz). The microcontroller 108 may be configured to operate in a particular frequency band based on factors such as, but not limited to, transponder 124 costs, physical range of interrogation/detection of the transponder 124, and so forth.

The microcontroller 108 may be configured to receive and decode a response signal. The response signal may be transmitted by the transponder 124 as a response to the interrogation signals, transmitted by the microcontroller 108. In an example, the response signal comprises a sequence of sixteen pulses, each pulse at one of two distinct frequencies in the same frequency band as the interrogation signals. Each pulse may include one or more cycles of a sinusoidal or other alternating waveform. The two distinct frequencies correspond to the two logic levels—logic 0 and logic 1. In one implementation, the microcontroller 108 may be configured to perform pulse measurement to determine a time period of the received response signal, at predefined measurement intervals (for example, 0.5 microsecond to 2 microsecond, for LF communication). The predefined measurement intervals may be synchronized to the pulses of the response signal. In another implementation for decoding the response signal, the microcontroller 108 may measure pulse width of each of the pulses of the response signal. In yet another example, the microcontroller 108 may decode the response signal by counting number of cycles and duration of the cycles for each of the pulses. In other words, the pulse measurement system effectively measures the frequency of the response signal, in terms of the time period.

The microcontroller 108 may be configured to decode the response signal by assigning logic levels based on the measured time period. For example, the microcontroller 108 may assign a logic low or a logic 0 to portions of the response signal at 123.2 kHz (approximately 8.11 microsecond time period), and assign a logic high or logic 1 to portions of the response signal at 134.2 kHz (approximately 7.45 microsecond time period). Based on the assigned logic levels, the microcontroller 108 may construct an authentication code, referred to herein as the received authentication code. The received authentication code may be a digital code of a predefined length, for example, 16 bits.

The microcontroller 108 may match the received authentication code to a list of pre-stored authentication codes, stored within the machine security system 102. The pre-stored authentication codes may be stored within the memory of the microcontroller 108, or may be stored in another memory unit (not shown), communicably coupled to the microcontroller 108. The microcontroller 108 then generates a control signal upon finding a successful match between the received authentication code, and a pre-stored authentication code. The control signal then effects the machine operation, such as, allowing an ignition of the machine 100, starting of the machine 100, unlocking of the machine 100, and so forth.

The antenna coil 110 is utilized by the microcontroller 108 for bi-directional wireless communication with the transponder 124. The antenna coil 110 radiates radio frequency (RF) pulses corresponding to the interrogation signal generated by the microcontroller 108. The antenna coil 110 also receives response signals transmitted by the transponder 124. The antenna coil 110 may be configured for operation in the frequency band of operation of the machine security system 102, for example, the LF band.

At the transmission side, the TX filtering and amplification unit 112, of the machine security system 102, may be configured to increase Signal to Noise Ratio (S/N) of one or more signals transmitted to the transponder 124. The TX filtering and amplification unit 112 increases the S/N of the one or more signals transmitted from the microcontroller 108 such that these signals are easily detected by the transponder 124, even in presence of external noise. As described earlier, the TX filtering and amplification unit 112 may include TX filter 114 and TX amplifier 116. The TX filter 114 may filter one or more noise signals from the signals received from the microcontroller 108 and to be transmitted to the transponder 124 through the antenna coil 110. The TX amplifier 116 may then amplify signals filtered by the TX filter 114 and apply these signals to the antenna coil 110.

Similarly, on the receiving side, the RX filtering and amplification unit 118 may be configured to increase S/N of one or more signals received from the transponder 124, via the antenna coil 110. As described earlier, the RX filtering and amplification unit 118 may include the RX filter 120 and the RX amplifier 122. The RX filter 120 may include a band pass filter such that signals within a pre-determined frequency band (for example, LF band between 120 kHz and 150 kHz) are transferred to the microcontroller 108, while other signals are attenuated. The RX filter 120 may thus eliminate unwanted signals, such as signals from nearby electromagnetic objects and/or circuits, from one or more signals. Alternatively, the RX filter 120 may be a low pass filter, a high pass filter, or a band reject filter.

The RX amplifier 122 may be configured to amplify the one or more signals received from the transponder 124 via the antenna coil 110. In an example, the RX amplifier 122 may be an electronic amplifier including devices such as, but not limited to, vacuum tubes, transistors, and the like. In another example, the RX amplifier 122 may be a RF power amplifier for amplifying RF signals obtained from the transponder 124 via the antenna coil 110. The RF power amplifier may convert low power RF signals into a signal of substantially higher power, such that these signals may be directly input to the microcontroller 108. In an example, the RX amplifier 122 may convert the low power RF signals to signals having voltage levels suitable for input to the microcontroller 108. For example, the RX amplifier 122 may convert the low power RF signals to signals at a voltage range of 3.3 Volts to 5 Volts.

In an embodiment, as depicted in FIG. 1, the TX filtering and amplification unit 112 and the RX filtering and amplification unit 118 may be a part of the machine security system 102 in the form of a discrete circuit having discrete components such as the TX filter 114, the TX amplifier 116, the RX filter 120 and the RX amplifier 122. In an alternate embodiment, an integrated chip (IC) may be included within the machine security system 102. The IC may be configured to perform functionalities of all the above stated discrete components, i.e. filtering and amplification of one or more signals at the transmission side and the receiving side. In such an embodiment, the IC may directly transmit one or more signals from the microcontroller 108 for driving the antenna coil 110. Similarly, the IC may directly receive one or more signals from the transponder 124 through the antenna coil 110.

The transponder 124 may be a passive radio frequency identification (RFID) device embedded in the machine key 104. The transponder 124 may be configured to transmit RFID signals for authentication of the machine key 104. The transponder 124 may send these signals when a capacitor (not shown), integrated in the transponder 124, is charged by an interrogation signal transmitted by the microcontroller 108. As described in the foregoing, one or more signals may be received, from the transponder 124, by the antenna coil 110. These signals may then be received by the RX filtering and amplification unit 118 via the antenna coil 110. The RX filtering and amplification unit 118 may filter and amplify the signals in order to increase the S/N of the signals. The signals may then be received by the microcontroller 108 for authentication of the machine key 104.

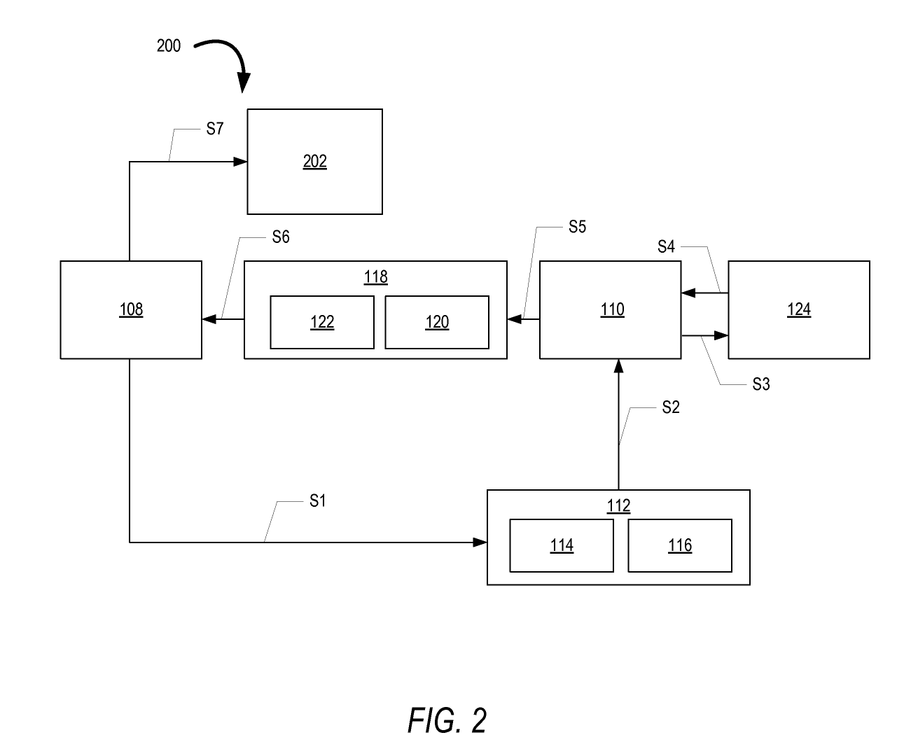

FIG. 2 illustrates a block diagram 200 of the machine security system 102, and one exemplary signal flow, according to various embodiments. As depicted by signals S1, S2 and S3, the microcontroller 108 may transmit the interrogation signal for charging the transponder 124. As depicted by signal S1, a digital signal may be transmitted by the microcontroller 108 to the TX filtering and amplification unit 112. The TX filtering and amplification unit 112 may process the digital signal for increasing the signal to noise ratio, and reducing the harmonic content of the digital signal, thus forming the interrogation signal. The TX filtering and amplification unit 112 then drives the antenna coil 110 by the interrogation signal, as depicted by signal S2. The microcontroller 108 may be programmed to send the interrogation signal at a preset frequency, for example, 134.2 kHz. The antenna coil 110 may receive the interrogation signal transmitted by the microcontroller 108, via the TX filtering and amplification unit 112, and radiate the interrogation signal as a RF signal for transmitting to the transponder 124. The transponder may receive the interrogation signal from the antenna coil 110 as depicted by signal S3.

The transponder 124 may generate response signals to be sent in response to the interrogation signal transmitted by the microcontroller 108. In an exemplary implementation, the transponder 124 may generate the response signals, when a capacitor integrated within the transponder 124 is charged by the interrogation signal. The response signals, in an example, may contain an authentication code, for authenticating the machine key 104, modulated thereon. In an exemplary implementation, the authentication code may be modulated upon these response signals using a binary Frequency Shift Keying (FSK) technique. In order to modulate the response signals with the authentication code, a pair of discrete frequencies may be used. Data pertaining to the authentication code may be encoded on the response signal using the two discrete frequencies in a binary manner. For example, for a binary authentication code, the logic low states (i.e. binary 0) and the logic high states (i.e. binary 1) are transmitted using RF signals at the two discrete frequencies. For example, a logic low or a logic 0 may be encoded as a 123.2 kHz pulse, and a logic high or logic 1 may be encoded as a 134.2 kHz pulse. These RF pulses may then be transmitted by the transponder 124 as response signals. In other exemplary implementations, other types of FSK may also be used for modulating the response signals with the authentication code associated with the machine key 104.

The response signals transmitted by the transponder 124 may be received by the antenna coil 110 as depicted by signal S4. These response signals may then be transmitted by the antenna coil 110 to the RX filtering and the amplification unit 118, as depicted by signal S5. The response signals may be fed into the RX filter 120 for removing noise and/or unwanted signals from the response signals. In an example, the RX filter 120 may be a band pass filter such that signals within a preset frequency band are passed from the RX filter 120 and rest of the signals are attenuated. Referring back to the example of binary FSK of the response signals using two discrete frequencies, the RX filter 120 may only pass signals lying within a range defined by the two discrete frequencies, i.e., the response signals. Signals other than response signals may thus be attenuated.

The response signals from the RX filter 120 may be received by the RX amplifier 122. The RX amplifier 122, in an example, may be a RF power amplifier. In an example, the amplifier 116 may be connected to an external energy source (not shown) for amplifying the response signals received from the RX filter 120. Examples of external energy source may include, but not limit to, batteries, fuel cells, and the like. Once the response signals are amplified by the RX amplifier 122, these signals are transmitted by the RX filtering and amplification unit 118 to the microcontroller 108 as depicted by signal S6.

The response signals are decoded by the microcontroller 108 to extract the authentication code of the transponder 124 (i.e. the received authentication code). In order to decode the response signals, the microcontroller 108 may calculate a time period of the response signals. Referring back to the foregoing example of binary FSK of the response signals, the microcontroller 108 may detect period of the response signals that are transmitted as analog waveforms using two discrete frequencies. The period of a waveform may be defined as reciprocal of the frequency of that waveform. Thus, the microcontroller 108 may detect the period of the response signals and based on the period may assign logic high states and the logic low states based on the two discrete frequencies received in the response signals. For example, the microcontroller 108 may assign a frequency of 123.2 kilohertz to logic low states and 134.2 kilohertz to logic high states. Based on assigning discrete frequencies to logic high states and logic low states, the microcontroller 108 may construct the received authentication code of the machine key 104 from the received response signals.

The microcontroller 108 may authenticate the machine key 104 by comparing the received authentication code to a list of authentication codes pre-stored in the microcontroller 108. The list of authentication codes, in an example, may be stored within a memory of the microcontroller 108. Based on the comparison of the decoded authentication code to the list of authentication codes, the microcontroller 108 may send a control signal to a machine control system 202. The microcontroller 108 may send a control signal to the machine control system 202 as depicted by signal S7.

The microcontroller 108 may send various control signals to the machine control system 202 based on authentication of the machine key 104. In an example, the microcontroller 108 may send an “ignition on” signal to the machine control system 202, such that ignition process of the machine 100 may be started by the machine control system 202. In such a scenario, the microcontroller 108 may send an “ignition off” signal to the machine control system 202 only when the machine key 104 is re-inserted in the key slot 106. Similarly, in case of the machine 100 being a vehicle, such as a car, the microcontroller 108 may send a “unlock” signal to the machine control system 202 when an authorized car-key is inserted in a key slot of a car door. In such a scenario, if an unauthorized car-key is used, the microcontroller 108 may transmit a “lock” signal to the machine control system 202 such that the car doors, steering wheel and engine ignition are simultaneously locked. Thus, unauthorized usage and theft of machines may be prevented.

### INDUSTRIAL APPLICABILITY

Machine 100 may be one of various types of machines, including transporting vehicles such as trucks, excavators, passenger vehicles, machine tools, industrial process controllers and the like. Machine 100 may be secured by a machine key 104 including a transponder 124. The machine 100 may function only after successful authentication of the machine key 104. The machine security system 102 authenticates the machine key 104. The machine security system 102 may provide benefits such as low complexity, low cost, high mean-time-between-failure (MTBF), and low footprint, owing to a single microcontroller implementation.

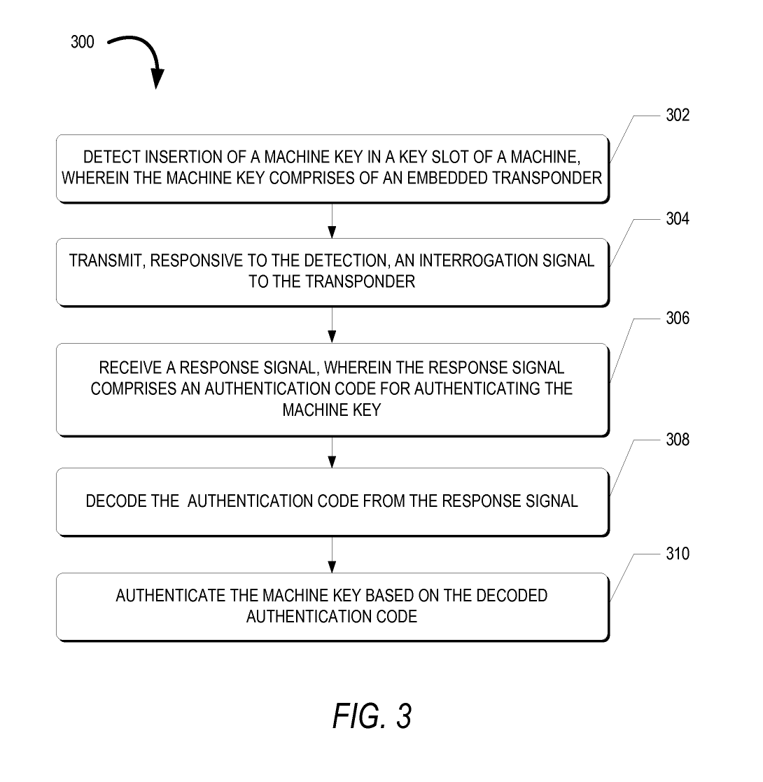

FIG. 3 illustrates a process flow 300 for authenticating a machine key. At step 302, insertion of the machine key 104 in the key slot 106 of the machine 100 is detected. As described in the foregoing, the machine key 104 may include an embedded transponder 124. The insertion of the machine key 104 in the key slot 106 of the machine 100 may be detected, in an example, by the microcontroller 108.

At step 304, an interrogation signal for charging the transponder 124 is transmitted. The interrogation signal may be a RF signal transmitted by the microcontroller 108 for charging the transponder 124. In an example, the interrogation signal may be first transmitted by the microcontroller 108 to the TX filtering and amplification unit 112. The TX filtering and amplification unit 112 may process the interrogation signal and transmit the processed interrogation signal to the transponder 124 using the antenna coil 110.

At step 306, a response signal is received by the microcontroller 108. The response signal may be received by the microcontroller 108 when the transponder 124 is substantially charged by the interrogation signal. In an example, the transponder 124 may include an integrated capacitor that may be charged with the interrogation signal. The response signal may be received by the microcontroller 108 via the RX filtering and amplification unit 118. In an embodiment, the response signal may be a radio frequency signal having an authentication code encoded thereon. The authentication code may be encoded upon the response signal, in an example, using FSK techniques. The authentication code may be used by the microcontroller 108 for authenticating the machine key 104.

At step 308, the microcontroller 108 decodes the received authentication code. In an example, the microcontroller 108 may decode the authentication code by detecting a period of the response signal and assigning two discrete frequencies for logic high states and logic low states.

At step 310, the microcontroller 108 authenticated the machine key 104 based on the decoded authentication code. The microcontroller 108 may authenticate the machine key 104 by comparing the decoded authentication code to a list of authentication codes preset within the microcontroller 108. In an example, the list of authentication codes may be stored within a memory of the microcontroller 108. In an embodiment, the microcontroller 108 may send control signals to the machine control system 102 based on success or failure of the authentication of the machine key 104. As described above, the control signals may include, without limitation, a lock signal, and unlock signal, an ignition on signal, an ignition off signal, and the like. Thus, the machine 100 may only perform operations based on the authentication of the machine key 104.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

1. A machine security system comprising:
a microcontroller configured to:
detect insertion of a machine key in a key slot of a machine, wherein the machine key comprises an embedded transponder;
transmit, responsive to the detection, an interrogation signal to the transponder;
receive, from the transponder, a response signal, wherein the response signal is received when the transponder is substantially charged by the interrogation signal, and wherein the response signal comprises an authentication code for authenticating the machine key;
decode the authentication code from the response signal; and
authenticate the machine key based on the decoded authentication code.

2. The machine security system of claim 1, wherein the microcontroller is electrically coupled to an antenna coil through a filtering and amplification unit for communicating with the transponder.

3. The machine security system of claim 2, wherein the filtering and amplification unit comprises a filtering circuit configured to filter one or more noise signals from the response signal, or the interrogation signal, or both.

4. The machine security system of claim 2, wherein the filtering and amplification unit further comprises an amplification circuit configured to amplify the response signal, or the interrogation signal, or both.

5. The machine security system of claim 1, wherein the authentication code is decoded from the response signal using at least one of a pulse width measurement, a pulse time period measurement and a cycle count measurement.

6. The machine security system of claim 1, wherein an integrated circuit chip is configured to filter one or more noise signals from the response signal.

7. The machine security system of claim 1, wherein an integrated circuit chip is configured to amplify the response signal.

8. The machine security system of claim 1, wherein at least one of the interrogation signal and the response signal is a radio frequency signal.

9. The machine security system of claim 1, wherein the response signal is modulated with the authentication code using a frequency shift keying modulation.

10. The machine security system of claim 1, wherein the microcontroller is further configured to authenticate the machine key based on matching of the decoded authentication code with one of a plurality of preset authentication codes.

11. The machine security system of claim 1, wherein the microcontroller is further configured to transmit a control signal to a machine control unit based on a success or a failure of the authentication of the machine key.

12. The machine security system of claim 11, wherein the control signal is one of a lock signal, an unlock signal, an ignition on signal, and an ignition off signal.

13. A method comprising:
detecting, by a microcontroller, insertion of a machine key in a key slot of a machine, wherein the machine key comprises of an embedded transponder;
transmitting, by the microcontroller, an interrogation signal for charging the transponder;
receiving, by the microcontroller, a response signal, wherein the response signal comprises an authentication code for authenticating the machine key;
decoding, by the microcontroller, the authentication code; and
authenticating, by the microcontroller, the machine key based on the decoded authentication code.

14. The method of claim 13, wherein the microcontroller is electrically coupled to an antenna coil through a filtering and amplification unit for communicating with the transponder.

15. The method of claim 13, further comprising filtering one or more noise signals from the response signal, or the interrogation signal, or both.

16. The method of claim 13, further comprising amplifying the response signal, or the interrogation signal, or both.

17. The method of claim 13, wherein the authentication code is decoded from the response signal using at least one of a pulse width measurement, a pulse time period measurement and a cycle count measurement.

18. The method of claim 13, further comprising transmitting, by the microcontroller, a control signal to a machine control unit based on a success or a failure of the authentication of the machine key.

19. The method of claim 18, wherein the control signal is one of a lock signal, an unlock signal, an ignition on signal, and an ignition off signal.

20. A system comprising:
a microcontroller configured to:
detect insertion of a machine key in a key slot of a machine, wherein the machine key comprises of an embedded transponder;
generate an interrogation signal, wherein the interrogation signal comprises a digital signal approximation of a sinusoidal or another periodic waveform;
transmit the interrogation signal;
receive a response signal comprising a plurality of pulses, wherein the plurality of pulses represent an authentication code for authenticating the machine key, and wherein the response signal is a radio frequency signal;
measure at least one of a pulse width, a pulse time period, and a cycle count for each of the plurality of pulses; and
determine the authentication code by assigning logic levels to each of the plurality of pulses based on the measuring.
